(19) United States
(12) Patent Application Publication
(10) Pub. No.: US 2025/0065556 A1
(43) Pub. Date: Feb. 27, 2025

(54) Method for controlling a facility for producing containers

(71) Applicant: SIDEL PARTICIPATIONS, OCTEVILLE-SUR-MER (FR)

(72) Inventors: Pierrick PROTAIS, OCTEVILLE-SUR-MER (FR); Julien GENDRE, OCTEVILLE-SUR-MER (FR); Arnaud DELAUNAY, OCTEVILLE-SUR-MER (FR)

(21) Appl. No.: 18/724,661

(22) PCT Filed: Dec. 27, 2022
(86) PCT No.: PCT/EP2022/087893

§ 371 Date: Jun. 27, 2024

(30) Foreign Application Priority Data
Dec. 30, 2021 (FR) FR2114704

(51) Int. Cl. B29C 49/78; B29C 49/42; B29L 31/00

(52) U.S. Cl. CPC B29C 49/783; B29C 49/42394; B29C 49/786; B29C 2049/78675; B29C 2049/78715; B29C 2049/7879; B29L 2031/7158

(57) ABSTRACT

The present invention relates to a method for manufacturing containers from thermoplastic materials by blow moulding or extrusion blow moulding a preform that has been pre-heated in a furnace then placed in a mould consisting of two half-moulds that define a moulding cavity, said preform being blown into the mould, optionally with a pre-blowing step. Said steps of heating the preforms, pre-blowing and blowing are controlled by a control unit on the basis of various control parameters such as the temperature in the furnace, the blowing pressure in the mould and/or the pre-blowing pressure and/or the pre-blowing flow rate and/or the speed of the stretching rod, for example. Said method is characterised in that it comprises at least the following steps: i) measuring the wall thickness of said containers at at least two different heights upon exiting the mould; ii) comparing the thickness measurements with setpoint values determined for each height of the containers; iii) if the difference between the thickness measurements and the determined setpoint values is greater than a determined threshold, modifying at least one of the control parameters, said modified control parameter(s) being selected at least by calculating the theoretical effects of the variation for each parameter on the thicknesses, then selecting the parameter or parameters that cause the smallest difference between the measured thickness values and the theoretical thickness values; iv) steps i) to iii) are repeated until the differences between the thickness measurements and the determined setpoint values are below said determined threshold.

### CROSS-REFERENCE TO RELATED APPLICATION

This application claims priority to Patent Cooperation Treaty Application No. PCT/EP2022/087893 filed Dec. 27, 2022, which claims priority to French Patent Application Serial No. 2114704 filed Dec. 30, 2021, the entirety of which is incorporated herein by reference.

### TECHNICAL FIELD

The present invention relates to the field of the manufacturing of containers, such as bottles or flasks for example, by blow molding or stretch blow molding from preforms made of thermoplastic material, such as for example polyethylene terephthalate, called “PET”. Its subject is a method for blow molding or stretch blow molding containers from preforms and a facility implementing such a method.

### STATE OF THE ART

In the field of the manufacturing of such containers, it is well known that the latter are manufactured through a facility comprising at least one heating unit and one forming unit equipped with a succession of molds with the die of the container model to be formed and with corresponding injection devices.

More specifically, the manufacturing of these containers comprises two main phases, namely a first so-called preform heating phase, during which a succession of preforms is heated in the heating unit to a reference temperature at which the preforms are in a malleable state in which they can be formed, and a second so-called forming phase, during which the heated preforms are each transferred into a mold of the blow molding unit and a fluid under pressure is injected into each preform by the injection device, also called corresponding nozzle, to give the preform the final form of the container. The fluid under pressure is usually a gas, such as air. Moreover, the forming generally includes a stretching phase performed by means of a movable stretching rod arranged to apply a stretching force onto the bottom of a preform in a mold in order to stretch the preform along its axis, which contributes to keeping the preform centered with respect to the mold.

Furthermore, a facility for producing these containers generally comprises a control console from which many parameters can be adjusted manually by an operator to drive the heating unit and/or the forming unit. With respect to the heating unit, said parameters consist, for example, of the heating power, the machine rate which modifies the scrolling speed of the preforms in the heating unit, the power of a ventilation ensuring the venting of a part of the heat in the heating unit; the temperature profile of the preferential heating, etc. With respect to the forming unit, said parameters consist, for example, of the pre-blow molding pressure, the start of the pre-blow molding, the pre-blow molding flow rate, the stretching speed, the blowing pressure, etc.

The manufacturing method entails numerous preliminary tests before a container deemed to conform is obtained, that is to say a container which meets all of the quality criteria defined previously by a specification. The operation is tedious and lengthy to implement, because it is essential to adjust each of the parameters of the facility and of the method in order to guarantee the conformity of the container. Furthermore, this preliminary step must be performed for each container format. The format of a container can notably be defined by the height, the form, the volume, and the material thereof.

The adjusting of the manufacturing method and the parameterizing of the associated facility therefore necessitates the presence of an operator with a good knowledge of the facility, of the method, and of the preform models likely to be introduced into the facility in order to obtain a container conforming to the desired format. This adjusting also necessarily takes a significant time, which directly impacts the production volume of the line.

The container obtained will then be assessed to determine whether or not it satisfies the criteria, and this is done throughout the production phase. For example, one quality criterion for judging the conformity of a container can be the distribution of the material along the height of the container, for a determined format. As is known, one of the parameters of the production method which impacts this criterion is the thermal conditioning of the preforms, as the preforms pass through the heating unit.

If this material distribution criterion is not deemed to conform, the operator must adjust different parameters in order to correct the defect, either during the thermal conditioning phase, or during the forming phase, or both. Furthermore, the modifications made must not lead to the appearance of other defects or problems.

In this respect, in order to mitigate this drawback, a method for regulating heating parameters of the oven has already been devised, notably for regulating variations of the electrical power of the radiation sources, as a function of the thickness of the wall of the container that is formed. That is notably the case in the European patent EP1998950.

The document EP1998950 proposes a solution consisting in monitoring the material distribution criterion using thickness sensors situated one on top of the other. If this criterion is deemed not to conform, the power of the heating lamp situated at the same height as a sensor will be modified accordingly. The other lamps are not affected and their setting is not rectified. Thus, the thermal conditioning of the preform is not therefore totally controlled.

Moreover, this modification of the heating parameters of the oven can lead to a modification of the thermal conditioning of the preform during production and thus generate a nonconformity of the container formed with respect to the specification of the client. Moreover, the nonconformity of the container formed puts a strain on the manufacturing costs and may necessitate the stopping of the facility, putting even more strain on the manufacturing costs.

Also known is the document EP2352633 which describes a method and an apparatus for blow molding containers. A preform made of a thermoplastic material is first of all subjected to a thermal treatment in the zone of a heating section along a transport path. The preform is then shaped as a container inside a blowing mold under the effect of a blowing pressure. Once the container has been molded by blow molding, a wall thickness is measured on at least one vertical level of the container. A predefined value for the thickness of the wall is transmitted to a controller as desired value, and the thickness of the wall measured is transmitted to the latter as real value. The controller predefines the quantity of at least one parameter influencing the blow molding process as a function of a difference between the desired value and the real value. More specifically, the controller predefines the quantity of at least one parameter influencing the supply of blowing gas. The quantity of the parameter is predefined on the basis of a simulation model of the blow molding process implemented in the controller.

All these solutions are inadequate because they do not allow the operator to optimize the heating phase directly and rapidly. The information available to him or her does not allow for a correction of the defect while avoiding having other problems appear, for example at other height levels of the container.

There is therefore a need to optimize the manufacturing method by simplifying the driving of the various steps and the parameterizing of the facility. Notably, there is a need to better control the preform conditioning phase, in a more targeted manner along the height of the containers, in order to shorten the time needed to obtain a first conformal container for a new format. It is also essential to be able to rapidly correct a defect detected during the manufacturing of containers and therefore adjust the various parameters effectively, in order not to impact the production flow.

### SUMMARY OF THE INVENTION

One of the aims of the invention is therefore to remedy these drawbacks by proposing a method that makes it possible to modify the thermal conditioning of the preforms and/or the container forming parameters without being required to stop the production facility and, in doing so, to maintain the quality of the containers produced.

To this end, and in accordance with the invention, a method is proposed for manufacturing containers made of thermoplastic materials by blow molding or stretch blow molding a preform previously heated in an oven and then disposed in a mold composed of two half-molds delimiting a molding cavity, said preform being blown in the mold, with, possibly, a pre-blowing step, said preform heating, pre-blowing and blowing steps being driven by a control unit on the basis of different so-called driving parameters such as the temperature in the oven, the blowing pressure in the mold and/or the pre-blowing pressure and/or the pre-blowing flow rate and/or the speed of the stretching rod for example; said method is noteworthy in that it comprises at least the following steps of:

i) measuring the thickness of the wall of said containers at the output of the mold, at at least two different heights;

ii) comparing the measurements of the thicknesses with the setpoint values determined for each height of the containers;

iii) if the deviation of the measurements of the thicknesses with the determined setpoint values is greater than a determined threshold, modifying at least one of the driving parameters of said modified driving parameter or parameters being selected at least by calculating the theoretical effects of the variation for each parameter on the thicknesses then by selecting the parameter or parameters inducing the smallest deviation between the measured values and the theoretical thickness values;

iv) the steps i) to iii) are repeated until the deviations of the measurements of the thicknesses with the determined setpoint values are less than said determined threshold.

It is well understood that, contrary to the methods of the prior art, the method according to the invention makes it possible to maintain the production quality of an existing bottle according to the environmental conditions and changes of preform.

Preferably, the step iii) comprises at least the following steps of:—defining, for each parameter, an optimal reference coefficient chosen from among reference coefficients assigned to each zone of thickness of the wall of the containers;—memorizing the lower and upper limits and scales for each of said parameters;—calculating an adjustment of each parameter as a function of said optimal reference coefficient previously defined;—calculating theoretical corrections for each zone of thickness as a unction of the calculated adjustments and the scales;—calculating the theoretical thickness deviation of the containers as a function of the theoretical corrections calculated for each zone of thickness;—adding up, for each parameter, said calculated theoretical deviations; and—selecting at least one parameter having the lowest aggregate deviation value.

Moreover, preferably, prior to the step of selecting at least one parameter, it comprises a step of ranking the parameters as a function of said calculated theoretical deviations.

Said parameters are ranked in ascending order, from the lowest aggregate deviation value to the highest aggregate deviation value.

In addition, after the step of calculating the deviations and prior to the step of calculating the theoretical corrections, it comprises an additional step of recalculating the deviations if the calculated deviations are not within said limits.

Moreover, the zero calculated theoretical corrections are excluded and the adding up of the calculated theoretical deviations is done as an absolute value.

In addition, the step of selecting the parameter is carried out after the calculation of a new average of the thicknesses for each zone and/or the combination of the deviations for each zone of thickness has changed.

Said new average of the thicknesses for each zone is calculated at a predetermined frequency.

Preferably, the new average of the thicknesses for each zone is calculated every m bottles output from the mold and measured, m being an integer number lying between 30 and 80.

Preferably, if, after n corrections on said selected parameter, n being a predetermined number greater than or equal to 1, the deviation of the measurements of the thicknesses with the determined setpoint values is greater than a determined threshold, a new parameter is selected.

Said selected new parameter i+1 corresponds to the ranked parameter i+1.

Advantageously, the optimal reference coefficients, of each parameter, assigned to each zone of thickness of the wall of the containers are variable and are calculated each time a parameter is modified.

Said calculation of the optimal reference coefficient assigned to each zone of thickness of the wall of the containers is obtained from the calculation of the real effect of the adjustment on each zone of thickness of the wall of the containers.

Said calculation comprises at least the following steps of:—Calculating an offset of the blowing and/or heating parameter by multiplying said initial coefficient by the thickness drift;—Determining the new coefficient as a function of the offset applied to the parameter and of the real effect measured on the material distribution of each zone of thickness.

Said parameter consists of a parameter of the heating unit such as the heating power at a determined height of the preform and/or the machine rate which modifies the scrolling speed of the preforms in the heating unit and/or the power of a ventilation ensuring the venting of a part of the heat in the heating unit and/or the temperature profile of the preferential heating.

Moreover, the parameter can also consist of a parameter of the forming unit such as the pre-blowing pressure value and/or the start of the pre-blowing and/or the pre-blowing flow rate and/or the speed of the stretching rod and/or the blowing pressure.

Secondarily, the method comprises a step of preselecting the parameters from a GUI, the acronym for “Graphical User Interface”, one or more parameters being associated with a predefined production configuration.

Preferably, it comprises at least three predefined production configurations, a so-called method configuration, a so-called applications configuration and a so-called options configuration.

Said so-called method configuration comprises at least two sub-configurations, namely a so-called heat resistance sub-configuration and a so-called preferential heating sub-configuration, one or more parameters being associated with each sub-configuration.

Said so-called application configuration comprises at least three sub-configurations, namely a so-called carbonated water sub-configuration, a so-called still water sub-configuration and a so-called petaloid product sub-configuration, one or more parameters being associated with each sub-configuration.

Said so-called options configuration comprises at least three sub-configurations, namely a so-called option-free sub-configuration, a so-called basic sub-configuration and a so-called search sub-configuration, one or more parameters being associated with each sub-configuration.

Another subject of the invention relates to a computer program product comprising a sequence of instructions which, when the program is run by a computer, causes the latter to implement the steps of the method according to the invention.

A third subject of the invention relates to a data processing device comprising means for implementing the steps of the method according to the invention.

A last subject of the invention relates to a computer-readable storage medium comprising instructions which, when they are executed by a computer, cause the latter to implement the steps of the method according to the invention.

### BRIEF DESCRIPTION OF THE DRAWINGS

Other advantages and features will emerge better from the following description of a single execution variant, given as a nonlimiting example, of the method according to the invention, with reference to the attached drawings in which:

FIG. 1 is a schematic representation, seen from above, of a forming facility implementing the method according to the invention,

FIG. 2 is a side view which represents a preform intended to supply the forming facility of FIG. 1,

FIG. 3 is a schematic representation of the different steps of forming of a container through the forming unit of FIG. 1,

FIG. 4 is a transverse cross-sectional view of the preform thermal conditioning unit of the forming unit of FIG. 1,

FIG. 5 is a schematic representation of the step of measuring the thickness of the wall of the container formed at different heights,

FIG. 6 is a flow diagram of the different steps of the method for regulating the container forming unit according to the invention.

### DETAILED DESCRIPTION OF THE INVENTION:

Hereinafter in the description of the method for manufacturing containers made of thermoplastic materials by blow molding or stretch blow molding a preform according to the invention, the same numeric references denote the same elements. The different views are not necessarily plotted to scale.

Hereinafter in the description, the elements that have an identical structure or similar functions will be designated by the same references.

Hereinafter in the description, orientations that are longitudinal directed in the direction of displacement of the hollow body, vertical and transverse as indicated by the trihedron “L, V, T” in the figures will be adopted in a nonlimiting manner.

Hereinbelow, the term “holding member” means gripping member or support member of a hollow body which can transport the hollow body from one point to another.

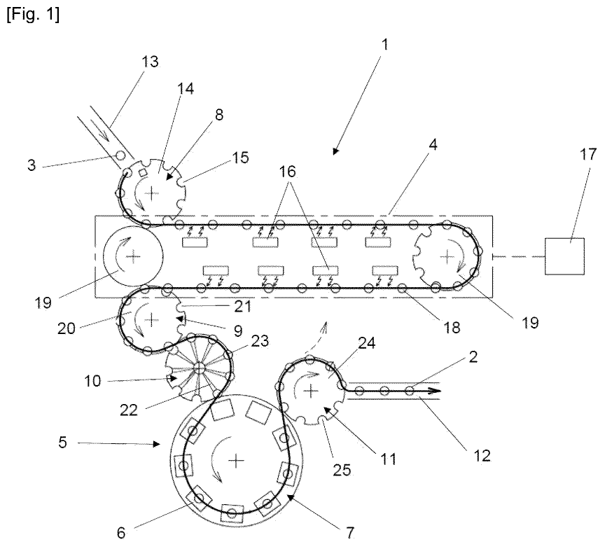

FIG. 1 represents a facility 1 for forming final containers 2 made of thermoplastic material, such as “PET” (polyethylene terephthalate), recycled or not, or “PP” (polypropylene), from preforms 3. The preforms 3 are generally produced beforehand by injection molding. These preforms 3 are generally cold when they are delivered to the input of the forming facility 1.

Hereinafter in the description, the generic term “hollow body” will be used to designate, without preference, a preform, a container currently being formed or a final container.

The facility 1 comprises several processing stations. Of the processing stations with which such facilities 1 are commonly equipped, represented here are a heating station 4 and a forming station 5 provided with several molding units 6 mounted at the periphery of a carousel 7.

It will be understood that the facility 1 can comprise other processing stations which are not represented here, such as a filling station, a labelling station, a plugging station, etc.

As a nonlimiting example, it is a facility 1 for forming containers 2 continuously. The hollow bodies are thus constantly in motion between their input into the facility 1 in the form of preforms 3 and their output in the form of final containers 2. This makes it possible to obtain a greater rate of production of containers 2. To this end, the facility 1 comprises several devices for transporting hollow bodies which are described hereinbelow.

As a variant, the invention is applicable to a facility operating sequentially.

The facility 1 comprises a first transfer wheel 8 at the input of the heating station 4, a second transfer wheel 9 at the output of the heating station 4, and a third transfer wheel 10 interposed between the second transfer wheel 9 and the forming station 5. Finally, a fourth transfer wheel 11 is arranged at the output of the forming station 5 for transferring the hollow bodies, here the final containers 2, to a conveyor 12 such as a belt or an air conveyor.

The hollow bodies scroll through the facility 1 along a determined production path which is indicated by a bold line in FIG. 1.

The hollow bodies arrive, in the form of preforms 3, successively one after the other by a ramp 13 which supplies the first transfer wheel 8, forming a first hollow body transport device. The first transfer wheel 8 takes the form of a disk 14 whose periphery is equipped with several support notches each forming a hollow body holding member 15. The holding members 15 are thus embedded on the disk 14.

The disk 14 is mounted to rotate about a central vertical axis “A” in a counterclockwise direction in referring to FIG. 1. The holding members 15 are thus displaced along a closed circuit of circular form about the axis “A”.

The hollow bodies, here the preforms 3, are conveyed from the ramp 13 to an input of the heating station 4 by following the production path. When one hollow body has been transmitted to the heating station 4, the holding member 15 continues its displacement empty along the closed circuit to return to its starting point and load a next hollow body. A useful section, represented by a bold line in FIG. 1, of said circuit forms an open section of the production path.

In a variant of the invention that is not represented, the holding members of the first transfer wheel are formed by hollow body gripping clamps.

Then, the hollow bodies, still in preform 3 form, are conveyed through the heating station 4 to be heated therein prior to the blow molding or stretch blow molding operations. To this end, the heating station 4 is equipped with heating means, such as lamps or diodes 16, emitting an electromagnetic radiation to heat up the material of the preforms 3, for example an infrared radiation, at a power and over a spectrum that are predetermined, which interacts with the material of the preform 3 to heat it up. The power and the spectrum are controlled by means of an electronic control unit 17.

It is quite clear that the lamps 16 will be able to be replaced by any other heating means well known to the person skilled in the art such as VCEL diodes emitting a monochromatic or pseudo-monochromatic electromagnetic radiation in the infrared or even microwave sources for example without in any way departing from the scope of the invention.

The heating station 4 is also equipped with ventilation means (not represented), such as fans or pulsed air devices also known as “air blades”. The ventilation means contribute to the regulation of the temperature of the hollow body. The ventilation means comprise air flow rate control means.

The parameterizing of each heating means is likely to be controlled to heat certain portions of the hollow body more or less. The parameterizing and notably the height of each heating means activated is for example controlled automatically by the electronic control unit 17.

Each hollow body is borne by a rotary mandrel, also called spinner, which forms a holding member 18 associated with the heating station 4. Such a holding member 18 conventionally comprises a mandrel (not represented) which is fitted into a neck of the hollow body, and a pinion meshing with a fixed rack running along the production path so as to ensure a substantially uniform rotation of the hollow body while it is being heated.

As a variant, each hollow body is driven in rotation by an individual electric motor. The rotation is then controlled by the electronic control unit 17.

The holding members 18 are borne by a closed chain which is driven in a clockwise direction by drive wheels 19 which are mounted to rotate about vertical axes “B”. This chain of holding members 18 set in motion thus forms a second hollow body transport device. Each holding member 18 is here displaced continuously, that is to say without interruption, along a closed circuit. A useful section, represented by a bold line in FIG. 1, of said circuit forms an open section of the production path.

At the output of the heating station 4, the hollow bodies, here the hot preforms 3, are then transmitted to the second transfer wheel 9 which has a structure similar to that of the first transfer wheel 8. This second transfer wheel 9 forms a third hollow body transport device.

After the transmission of the hollow body to the second transfer wheel 9, each holding member 18 of the heating station 4 continues its path empty along the closed circuit to return to its starting point and load a new hollow body.

The second transfer wheel 9 takes the form of a disk 20 whose periphery is equipped with several support notches each forming a hollow body holding member 21. The holding members 21 are thus embedded on the disk 20.

The disk 20 is mounted to rotate about a vertical central axis “C” in a counterclockwise direction in referring to FIG. 1. The holding members 21 are thus displaced along a closed circuit of circular form about the axis “C”.

The hollow bodies are conveyed from the output of the heating station 4 to the third transfer wheel 1 in following the production path. When one hollow body has been transmitted to the third transfer wheel 1, the associated holding member 23 continues its displacement empty along the closed circuit to return to its starting point and load a new hollow body. A useful section, represented by a bold line in FIG. 1, of said circuit forms an open section of the production path.

At the output of the second transfer wheel 9, hollow bodies, here the hot preforms 3, are transmitted to the third transfer wheel 1. This third transfer wheel 1 forms a fourth hollow body transport device.

Thus, the third transfer wheel 10 takes the form of a central hub whose periphery is equipped with several arms 22 radiating from the hub. The free end of each arm 22 is equipped with a clamp forming a hollow body holding member 23. The hub is mounted to rotate about a central vertical axis “D” in a clockwise direction in referring to FIG. 1. The holding members 23 are thus displaced along a closed circuit about the axis “D”.

The arms 22 can pivot about a vertical axis with respect to the hub or even extend telescopically to make it possible to vary the separation between two hollow bodies.

The hollow bodies are thus conveyed from the transfer wheel 9 to the forming station 5 by following the production path. When one hollow body has been transmitted to the forming station 5, the associated holding member 23 continues its displacement empty along the closed circuit to return to its starting point and load a new hollow body. A useful section, represented by a bold line in FIG. 1, of said circuit forms an open section of the production path.

When they are transferred to the forming station 5, each hollow body, here in the form of a hot preform 3, is inserted into one of the molding units 6 of the forming station 5. The molding units 6 are driven in continuous and regular movement about the vertical axis “E” of the carousel 7 in a counterclockwise direction in referring to FIG. 1. The molding units 6 are thus displaced along a closed circuit of circular form about the axis “E”.

While they are being formed, the hollow bodies are thus conveyed from the third transfer wheel 10 to the fourth transfer wheel 11. While they are being conveyed, the hollow bodies are transformed into final containers 2 by forming means which will be described schematically hereinbelow.

When one container 2 has been transmitted to the fourth transfer wheel 11, the associated molding unit 6 continues its displacement empty along the closed circuit to return to its starting point and load a new hollow body. A useful section, represented by a bold line in FIG. 1, of said circuit forms an open section of the production path.

At the output of the forming station 5, the hollow bodies are transmitted, in the form of final containers 2, to the fourth transfer wheel 11 which has a structure identical to that of the transfer wheel 10. This fourth transfer wheel 11 forms a sixth hollow body transport device.

Thus, the fourth transfer wheel 11 takes the form of a disk 24 whose periphery is equipped with several notches each of which forms a hollow body holding member 25. The holding members 25 are thus embedded on the disk 24.

The disk 24 is mounted to rotate about a vertical central axis “F” in a clockwise direction in referring to FIG. 1. The holding members 25 are thus displaced along a closed circuit of circular form about the axis “F”.

The hollow bodies are thus conveyed from the output of the forming station 5 to the conveyor 12 by following the production path. When one hollow body has been transmitted to the conveyor 12, the associated holding member 25 continues its displacement empty along the closed circuit to return to its starting point and load a new hollow body. A useful section, represented by a bold line in FIG. 1, of said circuit forms an open section of the production path.

In a variant of the invention that is not represented, the holding members of the fourth transfer wheel are formed by clamps.

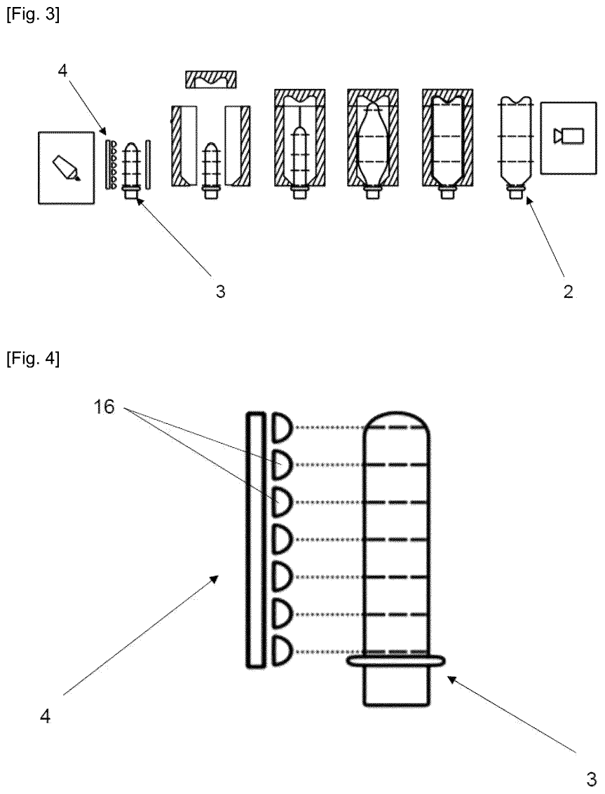

Thus, by referring to FIG. 3, each hollow body undergoes different processing steps during its travel along the production path, and notably a heating step in the heating station 4, followed by a forming step in the forming station 5.

Generally, such a forming facility 1 is likely to produce final containers 2 of different formats. To this end, the molding units 6 with which the forming station 5 is equipped are provided with interchangeable molds. Thus, it is possible to modify the form of the final container produced.

Depending on the format of the final container selected, the facility 1 will be supplied with preforms 3 having appropriate intrinsic characteristics.

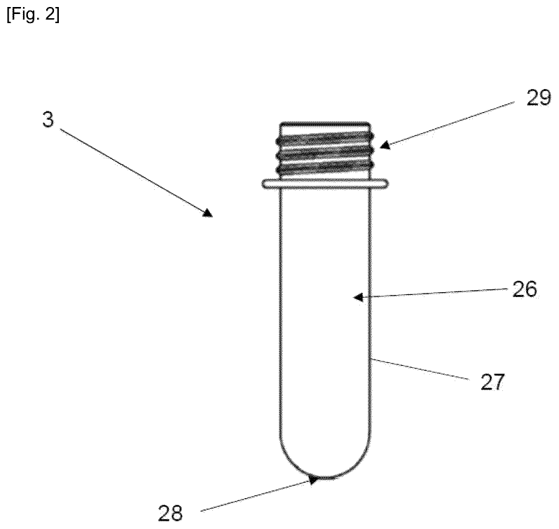

As represented in FIG. 2, a preform 3 has a cylindrical body 26 with a tubular wall 27 closed at one of its axial ends by a bottom 28, and which is prolonged at its other end by a neck 29, itself also tubular. The neck 29 is generally injected so as to already have its definitive form while the body 26 of the preform 3 is intended to undergo a relatively significant deformation to form the final container 2 in the forming step. The preforms 3 are here made of material made of “PET”, recycled or not, or of “PP”, that is to say that the preform 3 is produced by molding a single thermoplastic material of determined composition.

Of the characteristics likely to vary from one batch of preforms to another, the thickness of the wall 27 of the preform 3, or even the rate of absorption of infrared radiation by the thermoplastic material will for example be noted.

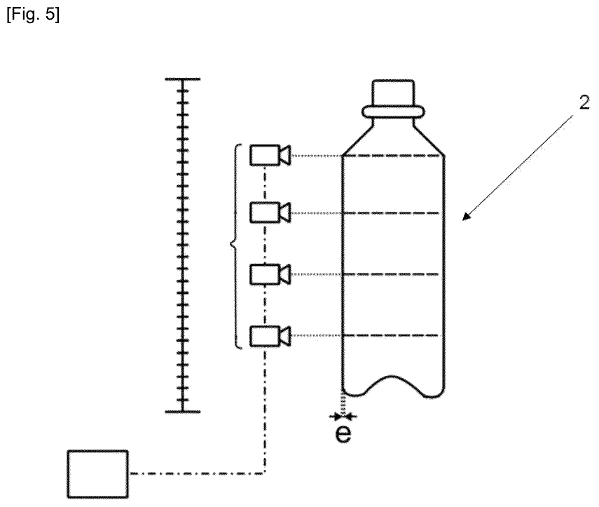

The invention proposes a method for controlling the facility 1 for forming hollow bodies that makes it possible to automatically set the processing parameters of the processing stations as a function of the measurements performed directly on the containers at the output of the forming station, as is illustrated schematically in FIG. 5. It will be observed that the thickness of the container is measured at at least two different heights by any appropriate means well known to the person skilled in the art, such as by interferometry sensors for example.

Thus, the method according to the invention consists in measuring the thickness of the wall of said containers at the output of the mold (step 100), at at least two different heights; then in comparing (step 200) the measurements of the thicknesses with the setpoint values determined for each height of the containers and, if the deviation of the measurements of the thicknesses with the determined setpoint values is greater than a determined threshold, in modifying (step 300) at least one of the driving parameters, said modified driving parameter or parameters being selected at least by calculating the theoretical effects of the variation for each parameter on the thicknesses then by selecting the parameter or parameters inducing the smallest deviation between the measured values and the theoretical thickness values and the preceding steps are repeated until the deviation of the thickness measurements with the determined setpoint values is less than said determined threshold.

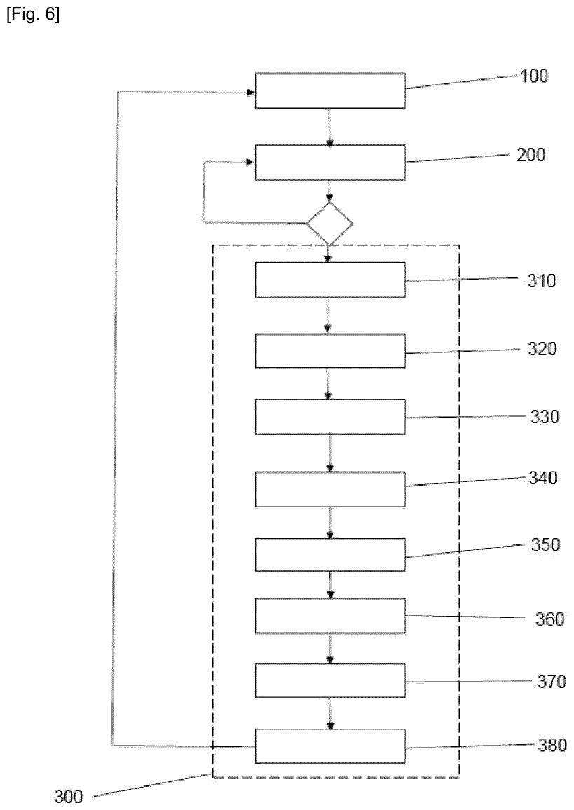

More specifically, referring to FIG. 6, the step of modifying (300) at least one of the driving parameters comprises at least the following steps of:
defining (310), for each parameter, an optimal reference coefficient assigned to each zone of thickness of the wall of the containers;
memorizing (320) the lower and upper limits and the scales for each of said parameters;
calculating an adjustment (330) of each parameter as a function of the optimal reference coefficient previously defined;
possibly recalculating (340) the adjustments if the calculated adjustments are not within said limits;
calculating theoretical corrections (350) for each zone of thickness as a function of the calculated adjustments and of the scales;
calculating the theoretical deviation (360) of thickness of the containers as a function of the theoretical corrections calculated for each zone of thickness;
adding up, for each parameter, said calculated theoretical deviations (370); and
selecting at least one parameter (380) having the lowest aggregate deviation value.

Prior to the step of selecting at least one parameter, it comprises a step of ranking the parameters as a function of said calculated theoretical deviations. Said parameters are ranked in ascending order, from the lowest aggregate deviation value to the highest aggregate deviation value.

Preferably, the zero calculated theoretical corrections are excluded and the adding up of the calculated theoretical deviations is done as an absolute value.

Advantageously, the step of selecting the parameter is performed after the calculation of a new average of the thicknesses for each zone and/or the combination of the deviations for each zone of thickness has changed. In this way, the regulation according to the invention makes it possible to correct the possible deviations in real time without having to stop the production facility and, thereby, to maintain the quality of the containers produced. A new average of the thicknesses for each zone is calculated at a predetermined frequency. For example, the new average of the thicknesses for each zone is calculated every m bottles output from the mold and for which the thicknesses have been measured, m being an integer number lying between 30 and 80. For example, m is equal to 50. However, it is obvious that m will be able to be any integer number without in any way departing from the scope of the invention.

It will be observed that, if, after n corrections on said selected parameter, n being a predetermined number greater than or equal to 1, the deviation of the measurements of the thicknesses with the determined setpoint values is greater than a determined threshold, a new parameter will then be selected. Said selected new parameter i+1 corresponds to the ranked parameter i+1.

Moreover, advantageously, the optimal reference coefficients assigned to each zone of thickness of the wall of the containers are variable and are calculated each time a parameter is modified. Said calculation of the optimal reference coefficient assigned to each zone of thickness of the wall of the containers is obtained from the calculation of the real effect of the adjustment on each zone of thickness of the wall of the containers.

Preferably, said calculation comprises at least the following steps of:
Calculating an offset of the blowing and/or heating parameter by multiplying said initial coefficient by the thickness drift;
Determining the new coefficient as a function of the offset applied to the parameter and of the real effect measured on the material distribution of each zone of thickness.

It will be observed that such variable optimal reference coefficients make it possible to customize these coefficients according to the environment, the machine, the resin of the preforms, etc.

Said parameter consists of a parameter of the heating unit such as the heating power at a determined height of the preform and/or the machine rate which modifies the scrolling speed of the preforms in the heating unit and/or the power of a ventilation ensuring the venting of a part of the heat in the heating unit and/or the temperature profile of the preferential heating, and/or said parameter consists of a parameter of the forming unit such as the value of the pre-blowing pressure and/or the start of the pre-blowing and/or the pre-blowing flow rate and/or the speed of the stretching rod and/or the blowing pressure.

Secondarily, in order to allow a fast and effective parameterizing of the regulation method according to the invention, the latter advantageously comprises a step of preselecting the parameters from a GUI, the acronym for “Graphical User Interface”, one or more parameters being associated with a predefined production configuration. To this end, the facility comprises at least one display screen, touch or otherwise, not represented in the figures, connected to the control unit of the facility.

For example, the GUI comprises at least three predefined production configurations, a so-called method configuration, a so-called applications configuration and a so-called options configuration.

Said so-called method configuration comprises at least two sub-configurations, namely a so-called heat resistance sub-configuration and a so-called preferential heating sub-configuration, one or more parameters being associated with each sub-configuration.

Said so-called application configuration comprises at least three sub-configurations, namely a so-called carbonated water sub-configuration, a so-called still water sub-configuration and a so-called petaloid product sub-configuration, one or more parameters being associated with each sub-configuration.

Said so-called options configuration comprises at least three sub-configurations, namely a so-called option-free sub-configuration, a so-called basic sub-configuration, and a so-called search sub-configuration, one or more parameters being associated with each sub-configuration.

It goes without saying that the GUI could comprise other predefined configurations and/or sub-configurations without in any way departing from the scope of the invention.

Finally, it is quite clear that the examples that have just been given are only particular illustrations that are in no way limiting as to the fields of application of the invention.

1. A method for manufacturing containers made of thermoplastic materials by blow molding or stretch blow molding a preform previously heated in an oven and then disposed in a mold composed of two half-molds delimiting a molding cavity, the preform being blown in the mold, with possibly a pre-blowing step, the preform heating, pre-blowing and blowing steps being driven by a control unit from different so-called driving parameters such as the temperature in the oven, the blowing pressure in the mold and/or the pre-blowing pressure and/or the pre-blowing flow rate and/or the speed of the stretching rod for example, wherein the method comprises at least the following steps of:
i) measuring the thickness of the wall of the containers at the output of the mold, at at least two different heights;
ii) comparing the measurements of the thicknesses with setpoint values determined for each height of the containers;
iii) if the deviation of the measurements of the thicknesses with the determined setpoint values is greater than a determined threshold, modifying at least one of the driving parameters, the modified driving parameter or parameters being selected at least by calculating the theoretical effects of the variation for each parameter on the thicknesses then by selecting the parameter or parameters inducing the smallest deviation between the measured thickness values and the theoretical thickness values; and
iv) the steps i) to iii) are repeated until the deviations of the measurements of the thicknesses with the determined setpoint values are less than the determined threshold.

2. The method as claimed in claim 1, wherein the step iii) comprises at least the following steps of:
defining, for each parameter, an optimal reference coefficient chosen from among reference coefficients assigned to each zone of thickness of the wall of the containers;
memorizing lower and upper limits and scales for each of the parameters;
calculating an adjustment of each parameter as a function of the optimal reference coefficient previously defined;
calculating theoretical corrections for each zone of thickness as a function of the calculated adjustments and the scales;
calculating the theoretical thickness deviation of the containers as a function of the theoretical corrections calculated for each zone of thickness;
adding up, for each parameter, the calculated theoretical deviations; and
selecting at least one parameter having the lowest aggregate deviation value.

3. The method as claimed in claim 2, wherein prior to the step of selecting at least one parameter, it comprises a step of ranking the parameters as a function of the calculated theoretical deviations.

4. The method as claimed in claim 3, wherein the parameters are ranked in ascending order, from the lowest aggregate deviation value to the highest aggregate deviation value.

5. The method as claimed in claim 2, wherein, after the step of calculating the adjustments and prior to the step of calculating the theoretical corrections, it comprises an additional step of recalculating the adjustments if the calculated adjustments are not within the limits.

6. The method as claimed in claim 2, wherein the zero calculated theoretical corrections are excluded.

7. The method as claimed in claim 2, wherein the adding up of the calculated theoretical deviations is done as an absolute value.

8. The method as claimed in claim 2, wherein the step of selecting the parameter is performed after the calculation of a new average of the thicknesses for each zone and/or the combination of the deviations for each zone of thickness has changed.

9. The method as claimed in claim 8, wherein a new average of the thicknesses for each zone is calculated at a predetermined frequency.

10. The method as claimed in claim 9, wherein the new average of the thicknesses for each zone is calculated every m bottles output from the mold and measured, m being an integer number lying between 30 and 80.

11. The method as claimed in claim 3, wherein, if, after n corrections on the selected parameter, n being a predetermined number greater than or equal to 1, the deviation of the measurements of the thicknesses with the determined setpoint values is greater than a determined threshold, a new parameter is selected.

12. The method as claimed in claim 11, wherein the selected new parameter i+1 corresponds to the ranked parameter i+1.

13. The method as claimed in claim 2, wherein the optimal reference coefficients, of each parameter, assigned to each zone of thickness of the wall of the containers are variable and are calculated each time a parameter is modified.

14. The method as claimed in claim 13, wherein the calculation of the optimal reference coefficient assigned to each zone of thickness of the wall of the containers is obtained from the calculation of the real effect of the adjustment on each zone of thickness of the wall of the containers.

15. The method as claimed in claim 14, wherein the calculation comprises at least the following steps of:
Calculating an offset of the blowing and/or heating parameter by multiplying the initial coefficient by the thickness drift;
Determining the new coefficient as a function of the offset applied to the parameter and of the real effect measured on the material distribution of each zone of thickness.

16. The method as claimed in claim 2, characterized in wherein the parameter consists of a parameter of the heating unit such as the heating power at a determined height of the preform and/or the machine rate which modifies the scrolling speed of the preforms in the heating unit and/or the power of a ventilation ensuring the venting of a part of the heat in the heating unit and/or the temperature profile of the preferential heating.

17. The method as claimed in claim 2, wherein the parameter consists of a parameter of the forming unit such as the value of the pre-blowing pressure and/or the start of the pre-blowing and/or the pre-blowing flow rate and/or the speed of the stretching rod and/or the blowing pressure.

18. The method as claimed in claim 1, further comprising a step of preselecting the parameters from a GUI, the acronym for “Graphical User Interface”, one or more parameters being associated with a predefined production configuration.

19. The method as claimed in claim 18, wherein it comprises at least three predefined production configurations, a so-called method configuration, a so-called applications configuration and a so-called options configuration.

20. The method as claimed in claim 19, wherein the so-called method configuration comprises at least two sub-configurations, namely a so-called heat resistance sub-configuration and a so-called preferential heating sub-configuration, one or more parameters being associated with each sub-configuration.

21. The method as claimed in claim 19, wherein the so-called application configuration comprises at least three sub-configurations, namely a so-called carbonated water sub-configuration, a so-called still water sub-configuration and a so-called petaloid product sub-configuration, one or more parameters being associated with each sub-configuration.

22. The method as claimed in claim 19, wherein the so-called options configuration comprises at least three sub-configurations, namely a so-called option-free sub-configuration, a so-called basic sub-configuration and a so-called search sub-configuration, one or more parameters being associated with each sub-configuration.

23. A computer program product comprising a sequence of instructions which, when the program is run by a computer, causes the latter to implement the steps of the method as claimed in claim 1.

24. A data processing device comprising means for implementing the steps of the method as claimed in claim 1.

25. A computer-readable storage medium comprising instructions which, when they are executed by a computer, cause the latter to implement the steps of the method as claimed in claim 1.
